(19) United States
(12) Patent Application Publication
(10) Pub. No.: US 2017/0142384 A1
(43) Pub. Date: May 18, 2017

(54) IMAGE PROCESSING APPARATUS, IMAGE PROCESSING METHOD, IMAGE PROJECTION SYSTEM, AND STORAGE MEDIUM

(71) Applicant: CANON KABUSHIKI KAISHA, Tokyo (JP)

(72) Inventor: Kazuhiro Yoshimura, Kawasaki-shi (JP)

(21) Appl. No.: 15/346,640

(22) Filed: Nov. 8, 2016

(30) Foreign Application Priority Data
Nov. 12, 2015 (JP) 2015-221993

(51) Int. Cl. H04N 9/31

(52) U.S. Cl. CPC H04N 9/3185; H04N 9/3147; H04N 9/3194

(57) ABSTRACT

An image processing apparatus derives a first transformation amount as a geometric transformation amount from a projection image to an input image to be displayed on a projected body respectively based on a plurality of captured images obtained by capturing a display image to be displayed on the projected body by a plurality of image capturing apparatuses of which image capturing areas are overlapped. The image processing apparatus obtains information regarding an overlapping area captured by the image capturing apparatuses are overlapped with each other. The image processing apparatus derives a second transformation amount as a geometric transformation amount from the projection image to the input image based on a plurality of the first transformation amounts and the information regarding the overlapping area. The image processing apparatus generates the projection image based on the first transformation amount and the second transformation amount.

### BACKGROUND OF THE INVENTION

Field of the Invention

The present invention relates to image processing for projecting an image to a projected body using a projection apparatus.

Description of the Related Art

Conventionally, multi-projection systems have been proposed which can project one large image by using a plurality of projection apparatuses (projectors) and connecting projection images projected from each projection apparatus on a screen. In the multi-projection system, it is necessary to perform geometric correction on projection images so that the projection images are smoothly connected with each other in overlapping areas therebetween. The geometric correction of the projection image can be performed based on a correspondence relationship between a feature point of the projection image projected by the projector and a feature point of a captured image obtained by capturing the projection image projected by the projector on the screen.

Japanese Patent No. 4615519 discusses performing the geometric correction of a projection image using captured images of a plurality of image capturing apparatuses for capturing images projected on a screen. Japanese Patent No. 4615519 discusses unifying coordinate systems of captured images of the plurality of image capturing apparatuses and performing the geometric correction on a projection image based on an image projection area on the unified coordinate system.

Regarding the technique described in the above-described Japanese Patent No. 4615519, it is necessary that positions, orientations, and image capturing parameters (focal lengths, image principal point positions, distortion aberrations, and the like) of the plurality of the image capturing apparatuses with respect to the screen are precisely obtained in order to appropriately perform the geometric correction of the projection image. It is because if these parameters include errors, a failure will occur in an image projected on the screen in an overlapping area in which image capturing areas of the plurality of the image capturing apparatuses are overlapped with each other. However, it is difficult to estimate these parameters with high precision, and the estimated result always includes an error.

### SUMMARY OF THE INVENTION

Aspects of the present invention are generally directed to suppression of a failure of an image after projection when geometric correction of the projection image is performed using captured images of a plurality of image capturing apparatuses.

According to an aspect of the present invention, an image processing apparatus for generating a projection image to be projected from a projection apparatus to a projected body includes a first derivation unit configured to derive a first transformation amount as a geometric transformation amount from the projection image to an input image to be displayed on the projected body respectively based on a plurality of captured images obtained by capturing a display image to be displayed on the projected body by a plurality of image capturing apparatuses of which image capturing areas are at least partially overlapped with each other, a first obtainment unit configured to obtain information regarding an overlapping area in which the image capturing areas of the plurality of the image capturing apparatuses are overlapped with each other, a second derivation unit configured to derive a second transformation amount as a geometric transformation amount from the projection image to the input image based on a plurality of the first transformation amounts derived by the first derivation unit and the information regarding the overlapping area obtained by the first obtainment unit, and a generation unit configured to generate the projection image to display the input image on the projected body based on the first transformation amount derived by the first derivation unit and the second transformation amount derived by the second derivation unit.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image processing apparatus according to an exemplary embodiment.

FIGS. 2A and 2B illustrate examples of a configuration of an image projection system.

FIG. 3 is a block diagram illustrating a configuration of an image processing unit.

FIG. 4 is a flowchart illustrating operations of the image processing apparatus.

FIG. 5 illustrates input/captured image correspondence information.

FIGS. 6A to 6C are examples of a pattern image for obtaining correspondence and captured images thereof.

FIGS. 7A to 7C illustrate a calculation method of projection/captured image correspondence information.

FIG. 8 is a block diagram illustrating a configuration of a projection image correction unit.

FIG. 9 is a flowchart illustrating projection image correction processing.

FIG. 10 illustrates an example of an overlapping area.

FIGS. 11A to 11D illustrate an effect of a first exemplary embodiment.

FIG. 12 illustrates influence of a size of an overlapping area on a projection image.

FIGS. 13A to 13E illustrate an effect of a second exemplary embodiment.

### DESCRIPTION OF THE EMBODIMENTS

Various exemplary embodiments of the present invention will be described in detail below with reference to the attached drawings. The exemplary embodiments described below are examples of means for implementing the present invention and to be appropriately modified or changed depending on a configuration and various conditions of an apparatus to which the present invention is applied, and the present invention may not necessarily be limited by the exemplary embodiments described below.

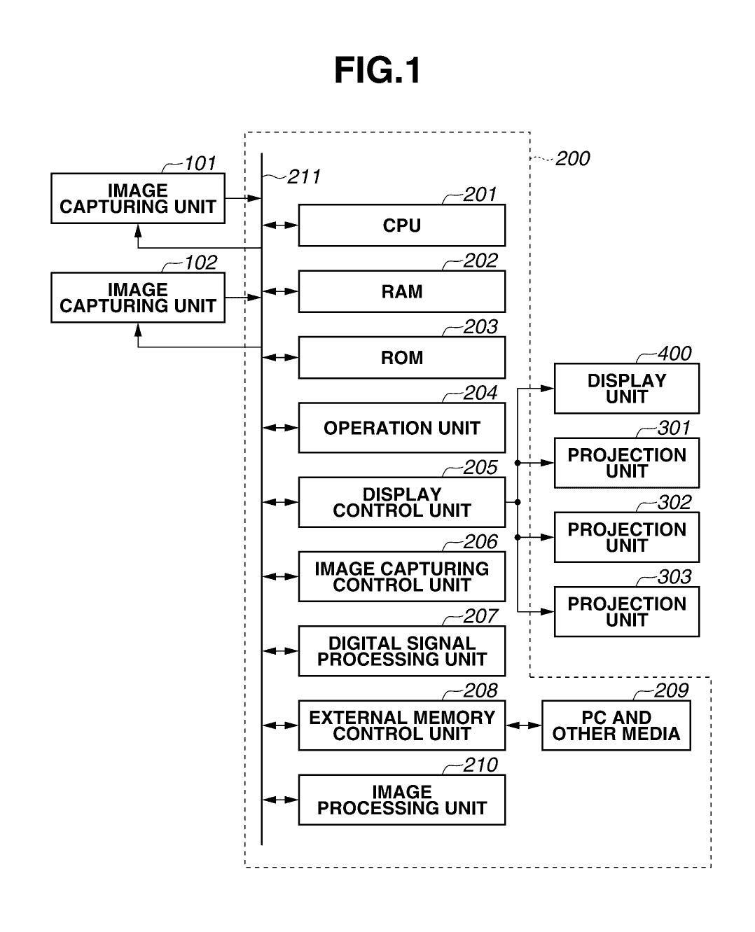

FIG. 1 illustrates a configuration example of an image projection system including an image processing apparatus according to a first exemplary embodiment. The image projection system is a system which divides an input image into a plurality of areas and projects partial images (projection images) on a projected body by each of a plurality of projection apparatuses (projection units). Further, the image projection system is a system which projects a single image by overlapping a part of a plurality of projection images projected by the plurality of projection units with one another and connecting the projection images on a single projected body. In other words, the image projection system is a multi-projection system which enables image display in a size exceeding a displayable range of the individual projection unit. In the present specification, an input image is an image to be ultimately displayed on the projected body.

The image projection system includes a plurality of image capturing units (cameras) 101 and 102, an image processing apparatus 200, a plurality of projection units (projectors) 301 to 303, and a display unit 400 as illustrated in FIG. 1. The image processing apparatus 200 includes a central processing unit (CPU) 201, a random access memory (RAM) 202, a read-only memory (ROM) 203, an operation unit 204, a display control unit 205, an image capturing control unit 206, a digital signal processing unit 207, an external memory control unit 208, a storage medium 209, an image processing unit 210, and a bus 211.

The CPU 201 of the image processing apparatus 200 comprehensively controls operations of the image processing apparatus 200 and controls each configuration unit (202 to 210) via the bus 211. The RAM 202 functions as a main memory and a work area of the CPU 201. The RAM 202 may temporarily store data pieces of a captured image, a projection image, and the like, which are described below. The ROM 203 stores a program necessary for the CPU 201 to execute processing. The operation unit 204 is used by a user to perform an input operation and includes various setting buttons and the like. The display control unit 205 performs display control of an image and a character displayed on the display unit 400 such as a monitor and performs display control of an image and a character displayed on a screen (not illustrated) as a projected body via the projection units 301 to 303. The image capturing control unit 206 controls the image capturing units 101 and 102 based on the processing executed by the CPU 201 or a user instruction input via the operation unit 204.

The digital signal processing unit 207 performs various types of processing such as white balance processing, gamma processing, and noise reduction processing on digital data received via the bus 211 and generates digital image data. The external memory control unit 208 is an interface for connecting the system to the external memory 209 which is a personal computer (PC) and other media. The external memory 209 includes a hard disk, a memory card, a compact flash (CF) card, a secure digital (SD) card, a universal serial bus (USB) memory, and the like. A program necessary for the CPU 201 to execute the processing may be stored in the external memory 209. The image processing unit 210 individually generates projection images projected by the respective projection units 301 to 303 to the screen. In this regard, the image processing unit 210 performs image processing described below using captured images obtained from the image capturing units 101 and 102 (or the digital image data output from the digital signal processing unit 207) and performs the geometric correction on partial images projected by the respective projection units 301 to 303.

The projection units 301 to 303 respectively project the partial images on a single screen according to the display control by the display control unit 205 of the image processing apparatus 200. The image capturing units 101 and 102 are constituted of a plurality of lenses and image sensors such as a complementary metal oxide semiconductor (CMOS) and a charge coupled device (CCD), and the like. According to the present image projection system, the image capturing units 101 and 102 are configured to be able to capture images of an object from respective different view points. According to the present exemplary embodiment, an object is a display image to be displayed on the screen when the projection images are projected by the projection units 301 to 303.

The function of each component illustrated in FIG. 1 can be realized by each dedicated hardware. In this regard, the function of each of the components (202 to 210) of the image processing apparatus 200 is operated based on the control by the CPU 201. At least a part of the function of each component illustrated in FIG. 1 may be realized by the CPU 201 executing a predetermined program.

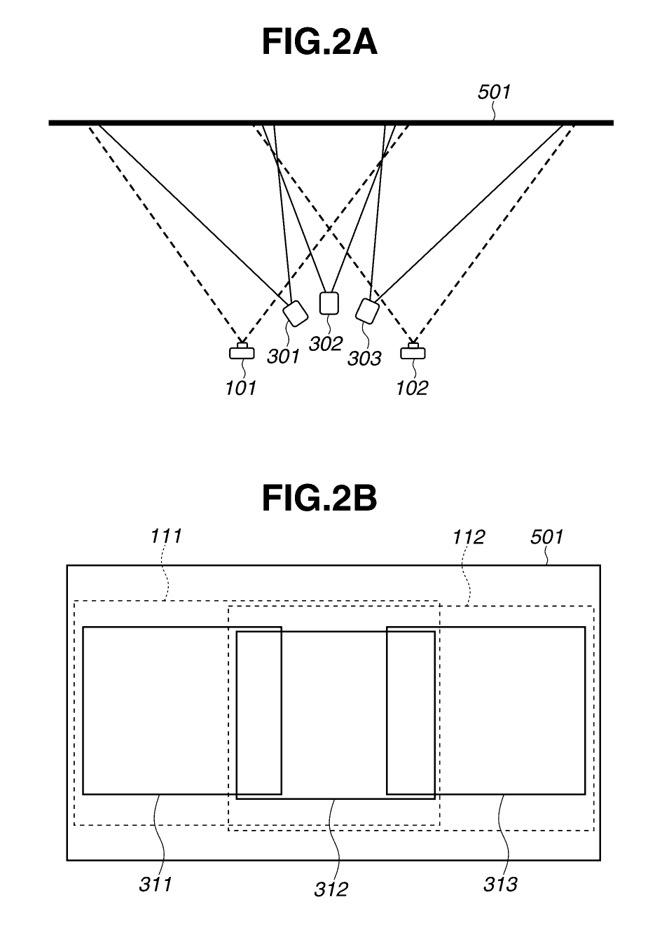

FIGS. 2A and 2B illustrate a configuration example of the image projection system and a positional relationship among the image capturing units 101 and 102, the projection units 301 to 303, and a screen 501 on which the projection units 301 to 303 project images. FIG. 2A is an upper view of an arrangement of these components, and FIG. 2B is a front view of the screen 501. According to the present exemplary embodiment, the screen 501 is a large plane screen.

In FIG. 2A, dotted lines extending from the image capturing units 101 and 102 indicate imaging view angles of the respective image capturing units. Solid lines extending from the projection units 301 to 303 indicate projecting view angles of the respective projection units. According to the present exemplary embodiment, the image capturing unit 101 and the screen 501, and the image capturing unit 102 and the screen 501 are respectively in relationships almost squarely facing each other.

In FIG. 2B, an area surrounded by a dotted line 111 is an image capturing area of the image capturing unit 101, and an area surrounded by a dotted line 112 is an image capturing area of the image capturing unit 102. An area surrounded by a solid line 311 is a projection area of the projection unit 301, an area surrounded by a solid line 312 is a projection area of the projection unit 302, and an area surrounded by a solid line 313 is a projection area of the projection unit 303. As illustrated in the drawing, the projection units 301 to 303 are arranged so that a part of a projection area 311 and a projection area 312, and a part of the projection area 312 and a projection area 313 respectively are overlapped with each other. Further, the image capturing unit 101 is arranged so that an image capturing area 111 includes the projection area 311, the projection area 312, and a part of the projection area 313, and the image capturing unit 102 is arranged so that an image capturing area 112 includes the projection area 312, the projection area 313, and a part of the projection area 311. In other words, the image capturing units 101 and 102 are arranged so that the image capturing area 111 and the image capturing area 112 are partially overlapped with each other.

According to the present exemplary embodiment, it is described that the screen 501 has a plane shape as illustrated in FIGS. 2A and 2B, however, the screen 501 may have a cylindrical or a complicated shape like a spherical surface. Further, according to the present exemplary embodiment, the system including two image capturing units and three projection units is described, however, the system is not limited to the above-described configuration as long as which includes a plurality of the image capturing units and the projection units. The arrangement positions and orientations of the image capturing units and the projection units are also not limited to the above-described configuration. According to the present exemplary embodiment, the multi-projection system including a plurality of the projection units is described, however, the system may include only one projection unit. In this case, the system may have a configuration in which a plurality of image capturing units captures a display image to be displayed on the screen when the one projection unit projects the projection image by overlapping at least a part of image capturing areas.

Next, a specific configuration of the image processing unit 210 is described.

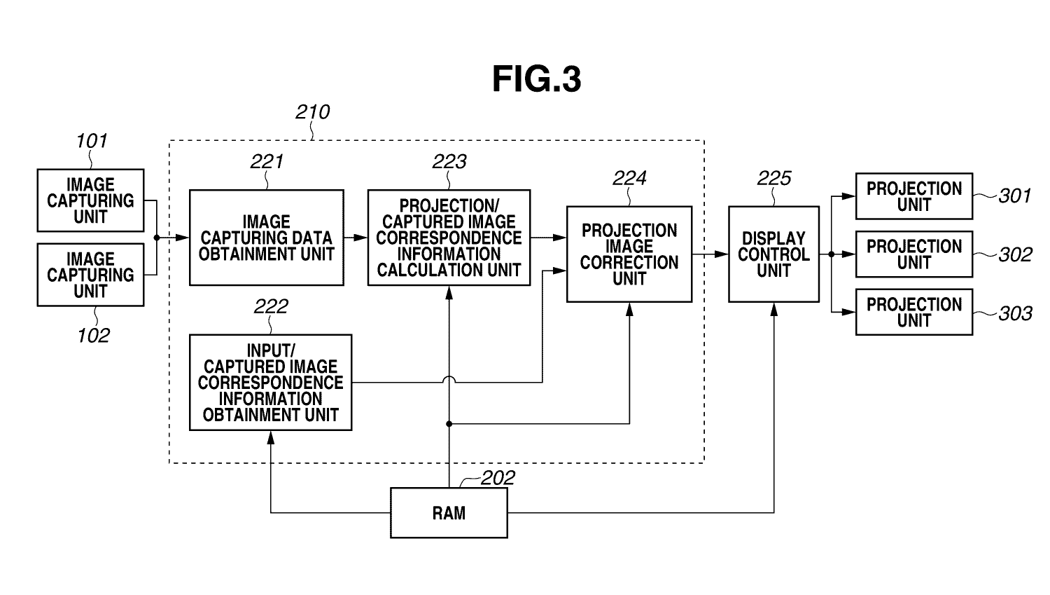

FIG. 3 is a block diagram illustrating the configuration of the image processing unit 210. The image processing unit 210 includes an image capturing data obtainment unit 221, an input/captured image correspondence information obtainment unit 222, a projection/captured image correspondence information calculation unit 223, and a projection image correction unit 224.

The image capturing data obtainment unit 221 obtains captured images respectively captured by the image capturing units 101 and 102. The input/captured image correspondence information obtainment unit 222 (hereinbelow, referred to as “the correspondence information obtainment unit 222”) obtains correspondence information (first correspondence information) of the input image and the captured image from the RAM 202. The first correspondence information is, for example, information indicating a correspondence relationship between pixels of the input image and the captured image obtained by capturing the input image displayed on the screen 501 which is expressed by a transform equation from an image coordinate system of the captured image to an image coordinate system of the input image. The correspondence information obtainment unit 222 obtains the first correspondence information pieces of the respective image capturing units 101 and 102.

The projection/captured image correspondence information calculation unit 223 (hereinbelow, referred to as “the correspondence information calculation unit 223”) calculates correspondence information (second correspondence information) of the projection image and the captured image obtained by capturing the image capturing area on the screen 501 on which the projection image is projected. The second correspondence information is, for example, information indicating a correspondence relationship between pixels of the projection image and the captured image obtained by capturing the display image to be displayed on the screen 501 when the projection image is projected which is expressed by a transform equation from an image coordinate system of the projection image to the image coordinate system of the captured image. The correspondence information calculation unit 223 obtains the second correspondence information corresponding to the image capturing unit 101 and the second correspondence information corresponding to the image capturing unit 102 with respect to the respective projection units 301 to 303.

The projection image correction unit 224 corrects the partial images obtained by dividing the input image to be displayed by the respective projection units 301 to 303 based on the first correspondence information obtained by the correspondence information obtainment unit 222 and the second correspondence information calculated by the correspondence information calculation unit 223. Subsequently, the projection image correction unit 224 outputs the corrected partial images to the display control unit 205 as the projection images to be projected from the respective projection units 301 to 303 to the screen 501.

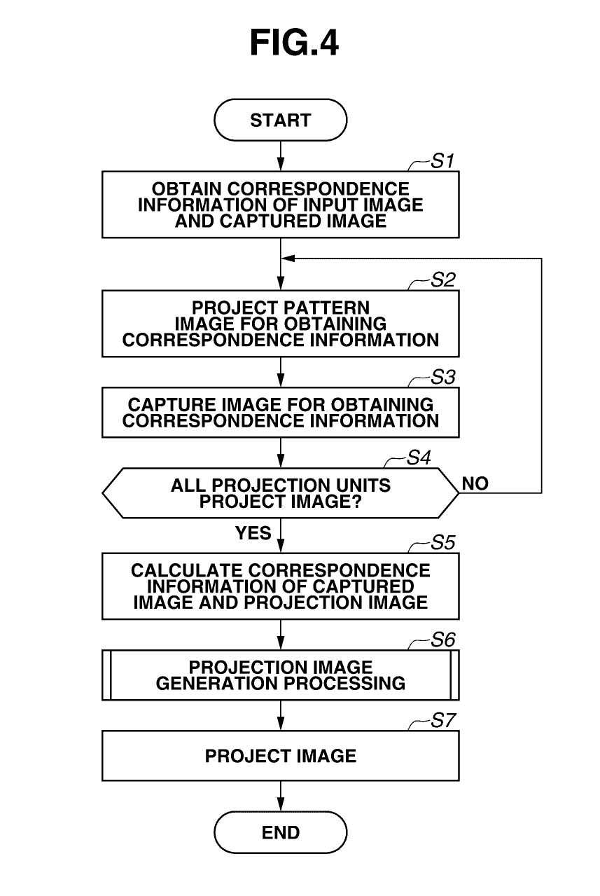

FIG. 4 is a flowchart illustrating operations of the image processing apparatus 200. According to the present exemplary embodiment, a case is described in which each component illustrated in FIG. 1 and FIG. 3 is operated as the dedicated hardware based on the control by the CPU 201, and thus the processing in FIG. 4 is realized. In this regard, the processing in FIG. 4 may be realized by the CPU 201 executing a predetermined program.

First, in step S1, the correspondence information obtainment unit 222 of the image processing unit 210 obtains the first correspondence information indicating the correspondence relationship of the input image and the captured image from the RAM 202.

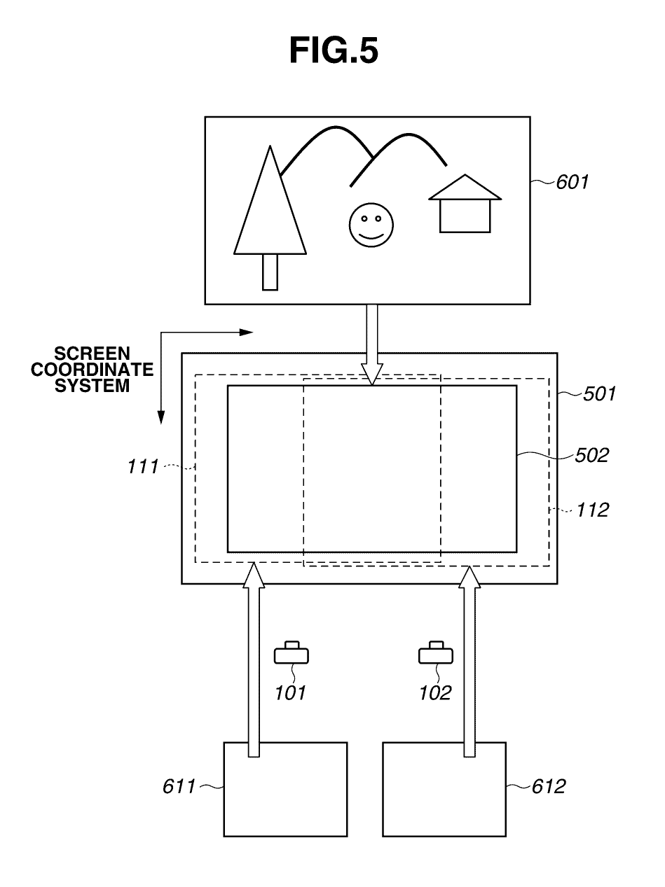

FIG. 5 illustrates the first correspondence information. FIG. 5 illustrates an input image 601, a captured image 611 of the image capturing unit 101, and a captured image 612 of the image capturing unit 102. According to the present exemplary embodiment, a correspondence relationship of the input image 601 and the captured image 611 and a correspondence relationship of the input image 601 and the captured image 612 are respectively expressed via a screen coordinate system. The screen coordinate system is a two-dimensional coordinate system indicating a screen surface of the screen 501. According to the present exemplary embodiment, the first correspondence information includes following three information pieces. The first one is a transform coefficient from the screen coordinate system to an image coordinate system of the input image 601. The second one is a transform coefficient from an image coordinate system of the input image 611 of the image capturing unit 101 to the screen coordinate system. The third one is a transform coefficient from an image coordinate system of the captured image 612 of the image capturing unit 102 to the screen coordinate system.

The transform coefficient from the screen coordinate system to the image coordinate system of the input image 601 is information indicating how the input image 601 is displayed on the screen 501. More specifically, the relevant information includes a display position, a display size (a display scale), an inclination, and the like of the input image 601 to the screen 501 when the input image 601 is displayed in a projection area 502 on the screen 501. The transform equation from the screen coordinate system to the image coordinate system of the input image 601 is expressed by a formula (1).

$$\begin{matrix}[ Equation 1 ] & \\ ( \begin{matrix}lu \\ lv \\ 1\end{matrix} ) = S ( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) ( \begin{matrix}x \\ y \\ 1\end{matrix} ) + S ( \begin{matrix}mu \\ mv \\ 1\end{matrix} ) & ( 1 )\end{matrix}$$

In the above-described formula (1), (lu, lv) are coordinate values of the image coordinate system of the input image 601, and (x, y) are coordinate values of the screen coordinate system. Further, S is a parameter for setting the above-described display size, [r11, r12, r13; r21, r22, r23; r31, r32, r33] are rotation matrices for setting the above-described inclination, and (mu, mv) are parameters for setting the above-described display position. When a user sets each of the parameters, the display position, the display size, and the inclination of the input image 601 to the screen 501 can be determined. The parameters set by the user are stored in the RAM 202.

According to the present exemplary embodiment, each parameter is set as follows, i.e., S=1.0, r11=1.0, r12=0.0, r13=0.0, r21=0.0, r22=1.0, r23=0.0, r31=0.0, r32=0.0, r33=1.0, mu=0.0, and mv=0.0. In other words, it is set as (lu, lv)=(x, y), and the transform equation from the screen coordinate system to the image coordinate system of the input image 601 is omitted to simplify the description.

Next, the transform coefficient from the image coordinate system of the image capturing unit 101 to the screen coordinate system is described. The transform coefficient from the image coordinate system of the input image 611 of the image capturing unit 101 to the screen coordinate system is information indicating where the image capturing unit 101 captures in the screen 501. According to the present exemplary embodiment, a transform equation of projective transformation from the captured image 611 of the image capturing unit 101 to the image capturing area 111 on the screen 501 is used for the transform equation from the image coordinate system of the input image 611 of the image capturing unit 101 to the screen coordinate system. The transform equation of the projective transformation (nomography) is expressed in formulae (2).

u=x*a+y*b+c−x*g*u−y*h*u,

v=x*d+y*e+f−x*g*v−y*h*v (2)

In the above-described formulae (2), (x, y) are coordinate values of an original plane, (u, v) are coordinate values of a target plane, and (a, b, c, d, e, f, g, h) are projective transform coefficients. The original plane is the captured image 611, and the target plane is the screen 501.

The correspondence information obtainment unit 222 obtains the above-described projective transform coefficient from the RAM 202 as the transform equation from the image coordinate system of the input image 611 of the image capturing unit 101 to the screen coordinate system. The same can be applied to the transform equation from the image coordinate system of the captured image 612 of the image capturing unit 102 to the screen coordinate system. The correspondence information obtainment unit 222 uses the transform equation of projective transformation from the captured image 612 of the image capturing unit 102 to the image capturing area 112 on the screen 501 for the transform equation from the image coordinate system of the captured image 612 of the image capturing unit 102 to the screen coordinate system. Further, the correspondence information obtainment unit 222 obtains the projective transform coefficient in the transform equation from the RAM 202.

In step S1 in FIG. 4, the correspondence information obtainment unit 222 applies the transform coefficient from the image coordinate system of the captured images of the image capturing units 101 and 102 to the screen coordinate system to the above-described formulae (2) and applies the transform coefficient from the screen coordinate system to the image coordinate system of the input image to the above-described equation (1). Accordingly, the correspondence information obtainment unit 222 can obtain the transform equations from the captured images of the respective image capturing units to the input image. The correspondence information obtainment unit 222 outputs the transform equation (the transform coefficient) from the captured image to the input image to the projection image correction unit 224 as the first correspondence information.

According to the present exemplary embodiment, the projective transform coefficient is obtained from the RAM 202, however, the projective transform coefficient may be calculated by calibration of the screen/image capturing unit. In this case, the correspondence information obtainment unit 222 generates four feature points on the screen and actually measures coordinate values of the four feature points in the screen coordinate system. Next, the correspondence information obtainment unit 222 captures the feature points on the screen by the image capturing unit and calculates coordinate values of the relevant feature points on the captured image. The correspondence information obtainment unit 222 associates these two coordinate values with each other and thus can calculate the projective transform coefficient.

According to the present exemplary embodiment, the correspondence information of the input image and the captured image which is expressed via the screen coordinate system is obtained, however, the correspondence relationship of the input image and the captured image can be directly obtained without the screen coordinate system. Further, for example, a Zhang's method may be used which is described in “Z. Zhang, “A flexible new technique for camera calibration”, IEEE Transactions on Pattern Analysis and Machine Intelligence, 22(11): 1330-1334, 2000”. The Zhang's method is to perform calibration of the image capturing unit using a feature point projected on a screen and estimate transformation from the image coordinate system of the image capturing unit to the screen coordinate system.

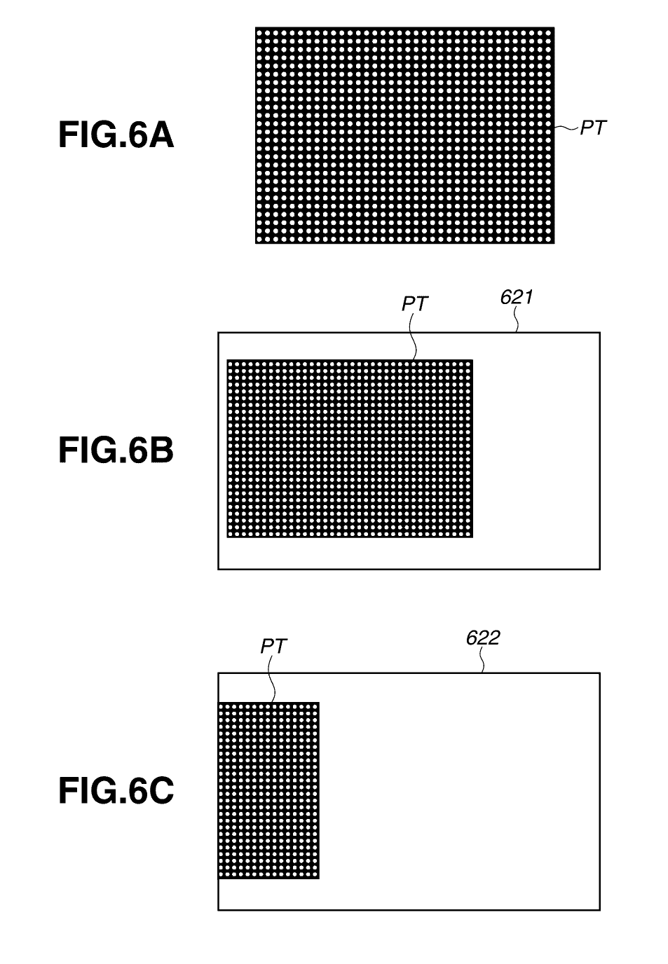

In step S2, the display control unit 205 instructs any one projection unit in the projection units 301 to 303 to project a predetermined pattern image for obtaining the correspondence information on the screen 501. FIG. 6A illustrates an example of a pattern image PT. According to the present exemplary embodiment, the pattern image PT is used in which many circles are regularly drawn in an entire image as illustrated in FIG. 6A. However, the pattern image PT is not limited to the image illustrated in FIG. 6A, and a natural image can be adopted as long as a feature portion can be extracted from the image.

In step S3, the image capturing control unit 206 instructs the image capturing units 101 and 102 to capture images of the respective image capturing areas 111 and 112 in the screen 501 on which the pattern image PT is projected. Further, the image capturing data obtainment unit 221 of the image processing unit 210 obtains images captured by the respective image capturing units 101 and 102. An image 621 illustrated in FIG. 6B is obtained in such a manner that the image capturing unit 101 captures an image of the image capturing area 111 in the screen 501 on which the pattern image PT illustrated in FIG. 6A is projected by the projection unit 301. An image 622 illustrated in FIG. 6C is obtained in such a manner that the image capturing unit 102 captures an image of the image capturing area 112 in the screen 501 on which the pattern image PT illustrated in FIG. 6A is projected by the projection unit 301.

The area on the screen 501 on which the projection unit 301 projects the pattern image PT is the projection area 311 illustrated in FIGS. 2A and 2B as described above. As illustrated in FIGS. 2A and 2B, the projection area 311 is included within the image capturing area 111 of the image capturing unit 101, so that the entire pattern image PT is captured in the captured image 621 of the image capturing unit 101 as illustrated in FIG. 6B. On the other hand, the image capturing area 112 of the image capturing unit 102 includes only a part of the projection area 311, so that only a part of the pattern image PT is captured in the captured image 622 of the image capturing unit 102 as illustrated in FIG. 6C.

In step S4, the display control unit 205 determines whether all the projection units 301 to 303 project the pattern image PT, and all the image capturing units 101 and 102 capture the projected pattern image PT. When it is determined that there is the projection unit which does not project the pattern image PT (NO in step S4), the display control unit 205 returns the processing to step S2, whereas when it is determined that all the projection units 301 to 303 project the pattern image PT, and all the image capturing units 101 and 102 capture the projected pattern image PT (YES in step S4), the display control unit 205 advances the processing to step S5.

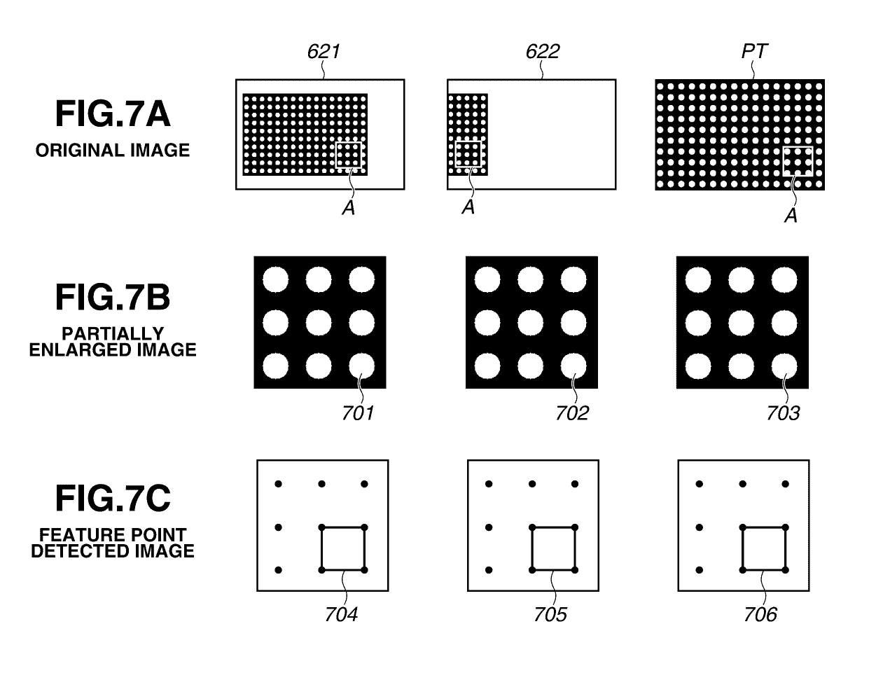

In step S5, the correspondence information calculation unit 223 calculates the second correspondence information indicating the correspondence relationship of the captured image and the projection image. First, the correspondence information calculation unit 223 obtains respective corresponding points in the pattern image PT (FIG. 6A) and the captured images 621 and 622 (FIGS. 6B and 6C) obtained by capturing the screen 501 on which the pattern image PT is projected. Details of the processing by the correspondence information calculation unit 223 is described with reference to FIGS. 7A to 7C using an example when the image capturing units 101 and 102 capture images of the screen 501 on which the projection unit 301 projects the pattern image PT.

FIG. 7A illustrates the projection image (the pattern image PT) of the projection unit 301, the captured image 621 of the image capturing unit 101, and the captured image 622 of the image capturing unit 102. FIG. 7B illustrates partially enlarged images obtained by enlarging areas A in the respective original images illustrated in FIG. 7A. FIG. 7C illustrates feature point detected images obtained by detecting the feature points from the partially enlarged images illustrated in FIG. 7B. According to the present exemplary embodiment, the circles drawn in the pattern image PT are the feature portions, and the centers of the circles are the feature points. Circles 701 and 702 in FIG. 7B are included in the captured images 621 and 622 of the image capturing units 101 and 102 which are respectively obtained by capturing a circle 703 included in the pattern image PT. The circles 701 to 703 are the same point on the screen 501. Further, areas 704 and 705 in FIG. 7C are surrounded by the four feature points (the centers of the circles) included in the captured images 621 and 622 of the image capturing units 101 and 102, and an area 706 is surrounded by the four feature points (the centers of the circles) included in the pattern image PT. The areas 704 to 706 are the same area on the screen 501.

In step S5 in FIG. 4, the correspondence information calculation unit 223 respectively associates the projection image (the pattern image PT) projected by the projection unit 301 with the captured image 621 of the image capturing unit 101 and the captured image 622 of the image capturing unit 102. More specifically, the correspondence information calculation unit 223 associates the feature point of the captured image 621 and the feature point of the pattern image PT with each other which indicate the same point and associates the feature point of the captured image 622 and the feature point of the pattern image PT with each other which indicate the same point. In other words, the correspondence information calculation unit 223 calculates that the center of the circle 701 in the captured image 621 and the center of the circle 703 in the pattern image PT are the same point and the center of the circle 702 in the captured image 622 and the center of the circle 703 in the pattern image PT are the same point. Further, the correspondence information calculation unit 223 performs the processing on all the circles included in the captured image and thus associates all the feature points included in the captured image with the feature points of the projection image.

According to the present exemplary embodiment, the correspondence information calculation unit 223 detects the circle from the image by circle detection processing and realizes the above-described association by performing labeling processing. The method for associating feature points is not limited to the above-described one, and a correspondent point searching method, a block matching method, and others can be used.

Next, the correspondence information calculation unit 223 calculates the projective transform equation from the original plane to the target plane based on the associated result of the feature point. The original plane is the projection image of the projection unit 301, and the target plane is the captured image of the image capturing unit 101 and the captured image of the image capturing unit 102.

In other words, the correspondence information calculation unit 223 calculates the projective transform coefficient in the above-described formulae (2) as in the case with the processing described above in step S1 and thus can obtain the projective transform equation from the projection image to the captured image. The above-described formulae (2) include eight projective transform coefficients, so that four corresponding points are required to calculate these projective transform coefficients. In this regard, it is known that the area 704 of the captured image of the image capturing unit 101 corresponds to the area 706 of the projection image of the projection unit 301 from the above-described association of the feature points. Thus, the correspondence information calculation unit 223 solves the simultaneous equations using coordinate values of the four feature points constituting the area 704 and coordinate values of the four feature points constituting the area 706 and can obtain the projective transform equations of the area 704 and the area 706.

The correspondence information calculation unit 223 performs the above-described processing on all areas in the captured image of the image capturing unit 101 and thus can calculate the projective transform equation from the projection image of the projection unit 301 to the captured image of the image capturing unit 101. The same can be applied to the projective transform equation from the projection image of the projection unit 301 to the captured image of the image capturing unit 102. The same can also be applied to the projection units 302 and 303. The correspondence information calculation unit 223 outputs the calculated projective transform equation group (the transform coefficient group) to the projection image correction unit 224 as the second correspondence information.

In step S6, the projection image correction unit 224 obtains the transform equation group (the first correspondence information) from the captured image of each image capturing unit to the input image output by the correspondence information obtainment unit 222. Further, the projection image correction unit 224 obtains the transform equation group (the second correspondence information) from the projection image of each projection unit to the captured image of each image capturing unit output by the correspondence information calculation unit 223. Furthermore, the projection image correction unit 224 obtains the input image from the RAM 202. Then, the projection image correction unit 224 generates the projection images to be projected by the respective projection units to display the input image on the screen 501 based on each obtained information and outputs the generated projection images to the display control unit 205. The projection image generation processing executed by the projection image correction unit 224 is described in detail below.

In step S7, the display control unit 205 outputs the projection image of each projection unit input from the projection image correction unit 224 to the corresponding projection unit. Accordingly, the projection units 301 to 303 project the projection images to the screen 501.

The projection image generation processing executed by the projection image correction unit 224 is described in detail below.

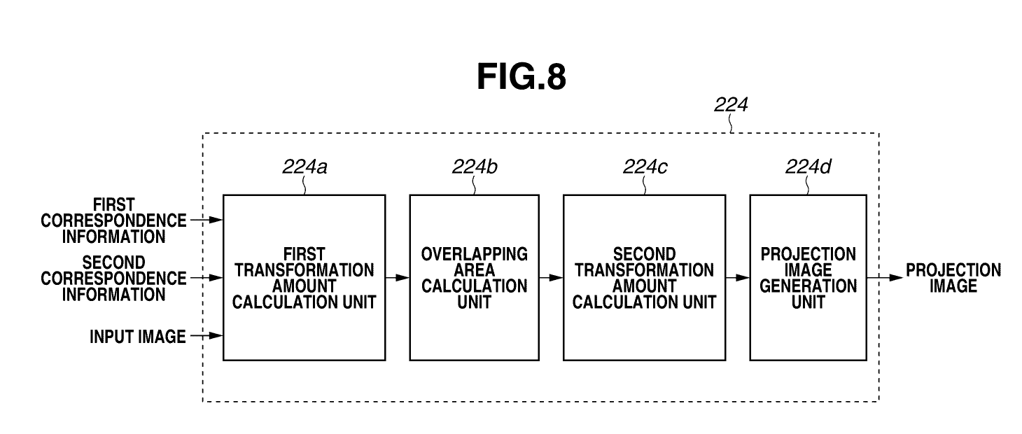

FIG. 8 is a block diagram illustrating the configuration of the projection image correction unit 224. The projection image correction unit 224 includes a first transformation amount calculation unit 224a, an overlapping area calculation unit 224b, a second transformation amount calculation unit 224c, and a projection image generation unit 224d.

The first transformation amount calculation unit 224a calculates a geometric transformation amount from the projection image of each projection unit to the input image as a first transformation amount based on the first correspondence information and the second correspondence information. The first transformation amount calculation unit 224a calculates each transform equation from the image coordinate system of the projection image to the image coordinate system of the input image as the first transformation amount via the image coordinate system of the captured image of each image capturing unit. The overlapping area calculation unit 224b calculates information regarding an overlapping area in which the image capturing area 111 of the image capturing unit 101 and the image capturing area 112 of the image capturing unit 102 are overlapped with each other.

The first transformation amount calculation unit 224a respectively calculates the first transformation amounts based on the correspondence information of the image capturing unit 101 and the correspondence information of the image capturing unit 102, so that a plurality of the first transformation amounts (the same as the number of the overlapping captured images) are obtained in an area corresponding to the overlapping area of the captured image. The second transformation amount calculation unit 224c unifies the plurality of the first transformation amounts in the overlapping area to a single transformation amount and calculates a unified new transformation amount (a geometric transformation amount from the projection image to the input image) as a second transformation amount. The projection image generation unit 224d generates the projection image of each projection unit to display the input image on the screen 501 based on the first transformation amount and the second transformation amount.

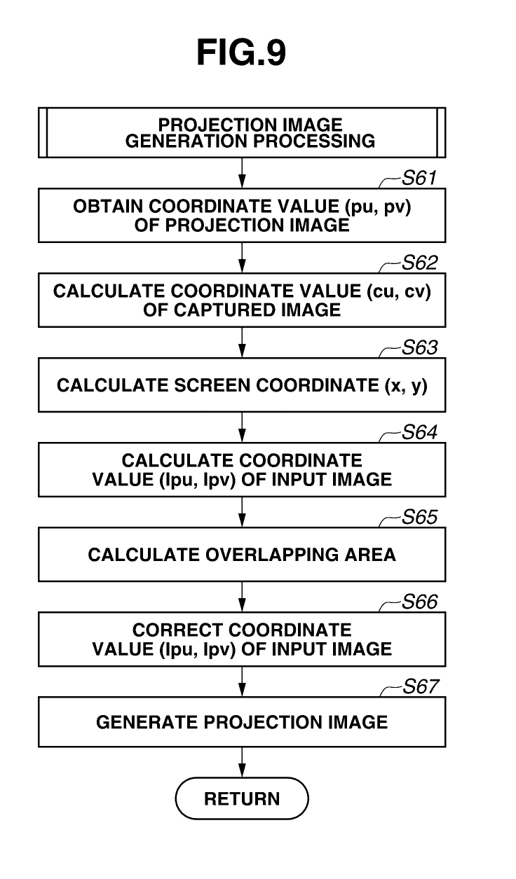

FIG. 9 is a flowchart illustrating procedures of the projection image generation processing executed by the projection image correction unit 224. The projection image generation processing is executed in step S6 in FIG. 4. In other words, according to the present exemplary embodiment, a case is described in which each component illustrated in FIG. 8 is operated as the dedicated hardware based on the control by the CPU 201, and thus the processing in FIG. 9 is realized. In this regard, the processing in FIG. 9 may be realized by the CPU 201 executing a predetermined program.

First, the first transformation amount calculation unit 224a calculates the transform equation (the first transformation amount) for transforming from the image coordinate system of the projection image of each projection unit to the image coordinate system of the input image based on the first correspondence information and the second correspondence information. The calculation processing of the first transformation amount is executed as described below in steps S61 to S64. The calculation processing of the first transformation amount is described below using an example in which coordinate values of the input image are calculated which correspond to coordinate values of the projection image of the projection unit 301.

In step S61, the first transformation amount calculation unit 224a obtains coordinate values (pu, pv) of a target pixel in the projection image of the projection unit 301 and advances the processing to step S62. In step S62, the first transformation amount calculation unit 224a calculates coordinate values (cu, cv) of the captured image corresponding to the coordinate values (pu, pv) of the projection image by applying the projective transform coefficient calculated in step S5 in FIG. 4. In step S62, the first transformation amount calculation unit 224a calculates coordinate values (cu_1, cv_1) of the captured image of the image capturing unit 101 and coordinate values (cu_2, cv_2) of the captured image of the image capturing unit 102 as the coordinate values (cu, cv) of the captured image.

Next, in step S63, the first transformation amount calculation unit 224a calculates the coordinate values (x, y) in the screen coordinate system of the screen 501 corresponding to the coordinate values (cu, cv) of the captured image calculated in step S62 by applying the projective transform coefficient obtained in step S1 in FIG. 4. In other words, in step S63, the first transformation amount calculation unit 224a calculates coordinate values (x_1, y_1) and (x_2, y_2) in the screen coordinate system respectively corresponding to the coordinate values (cu_1, cv_1) and (cu_2, cv_2) of the captured images of the respective image capturing units.

In step S64, the first transformation amount calculation unit 224a transforms the screen coordinates (x, y) calculated in step S63 to coordinate values (lpu, lpv) of the input image based on the transform equation from the screen coordinate system to the image coordinate system of the input image obtained in step S1 in FIG. 4. In other words, in step S64, the first transformation amount calculation unit 224a calculates coordinate values (lpu_1, lpv_1) and (lpu_2, lpv_2) of the input image respectively corresponding to the coordinate values (x_1, y_1) and (x_2, y_2) in the screen coordinate system calculated with respect to each image capturing unit.

By the processing from steps S61 to S64, the coordinate values of the input image corresponding to the coordinate values of the projection image of the projection unit 301 can be calculated. According to the present exemplary embodiment, the coordinate values of the input image corresponding to the coordinate values of the projection image have two values in a partial area in the projection area on the screen 501. The partial area corresponds to the overlapping area in which the image capturing area 111 of the image capturing unit 101 and the image capturing area 112 of the image capturing unit 102 are overlapped with each other. Further, the two values are the coordinate values (lpu_1, lpv_1) of the input image calculated via the image coordinate system of the captured image of the image capturing unit 101 and the coordinate values (lpu_2, lpv_2) of the input image calculated via the image coordinate system of the captured image of the image capturing unit 102. In the overlapping area of the image capturing area, two pairs of the coordinate values (lpu_1, lpv_1) and (lpu_2, lpv_2) of the input image corresponding to one pair of the coordinate values (pu, pv) of the projection image are different from each other.

In this regard, on the outside of the overlapping area, only one pair of the coordinate values of the input image corresponding to one pair of the coordinate values (pu, pv) of the projection image is calculated. More specifically, the coordinate values of the input image corresponding to the coordinate values of the projection image of the projection unit 301 not included in the overlapping area is calculated only one pair via the image coordinate system of the captured image of the image capturing unit 101. Similarly, the coordinate values of the input image corresponding to the coordinate values of the projection image of the projection unit 303 not included in the overlapping area is calculated only one pair via the image coordinate system of the captured image of the image capturing unit 102.

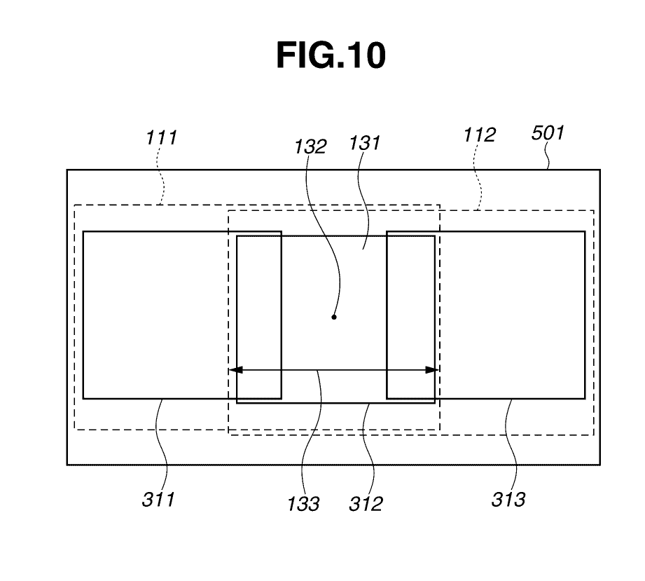

Next, in step S65, the overlapping area calculation unit 224b calculates the overlapping area in which the image capturing area 111 of the image capturing unit 101 and the image capturing area 112 of the image capturing unit 102 are overlapped with each other. More specifically, the overlapping area calculation unit 224b calculates a center position 132 and a size (width) 133 of the overlapping area 131 of the image capturing area 111 and the image capturing area 112 as the information regarding the overlapping area as illustrated in FIG. 10. According to the present exemplary embodiment, a shape of the overlapping area 131 is a rectangle shape to simplify the description, however, the overlapping area 131 may have another shape. In this case, the overlapping area calculation unit 224b may calculate information indicating a shape of the overlapping area 131 as information regarding the overlapping area 131.

The overlapping area calculation unit 224b calculates coordinate values of the center position 132 and pixel numbers corresponding to the width 133 of the overlapping area 131 in the image coordinate system of any one image capturing unit of a plurality of the image capturing units of which the image capturing areas are overlapped with each other. According to the present exemplary embodiment, the coordinate values of the center position 132 and the pixel numbers corresponding to the width 133 of the overlapping area 131 are calculated in the image coordinate system of the image capturing unit 101. The overlapping area calculation unit 224b calculates the coordinate values of the center position 132 as (centeru, centerv) and the width 133 as “width”.

In step S66, the second transformation amount calculation unit 224c corrects the coordinate values (lpu, lpv) of the input image calculated in step S64. More specifically, the second transformation amount calculation unit 224c transforms the two pairs of the coordinate values (lpu_1, lpv_1) and (lpu_2, lpv_2) of the input image calculated in the overlapping area 131 to one pair of the coordinate values (lpu, lpv). A calculation equation of the coordinate values (lpu, lpv) is indicated in following formulae (3). In the following formulae (3), w is a weight corresponding to a distance from the center position 132 in a width direction of the overlapping area 131. Further, in the following formulae (3), cu is a coordinate value in the image coordinate system of the image capturing unit which is used as a calculation reference of the coordinate value centeru of the center position 132 in the overlapping area 131, and according to the present exemplary embodiment, a coordinate value cu_1 in the image coordinate system of the image capturing unit 101 is used.

$$\begin{matrix}[ Equation 2 ] & \\ w = 1 - \frac{( cu - ( centeru - \frac{width}{2} ) )}{width} \\ lpu = w * lpu\_ 1 + ( 1 - w ) * lpu\_ 2 \\ lpv = w * lpv\_ 1 + ( 1 - w ) * lpv\_ 2 & ( 3 )\end{matrix}$$

The second transformation amount calculation unit 224c performs the above-described processing on all the coordinate values in the overlapping area 131. The example is described here in which the coordinate values of the input image corresponding to the coordinate values of the projection image of the projection unit 301 are calculated, and the same can be applied to the projection units 302 and 303.

As described above, in step S66 in FIG. 9, the second transformation amount calculation unit 224c calculates the coordinate values (lpu, lpv) of the input image corresponding to the coordinate values (pu, pv) of each pixel in the projection images of the respective projection units 301 to 303 one by one in an area corresponding to the overlapping area of the image capturing area. In other words, the second transformation amount calculation unit 224c calculates the second transformation amount as the geometric transformation amount from the projection image to the input image in the area corresponding to the overlapping area of the image capturing area with respect to each of a plurality of the projection units one by one.

According to the present exemplary embodiment, the case is described in which the image capturing areas of the two image capturing units are overlapped in the width direction (a right and left direction in FIG. 10). However, the similar processing can be performed when the image capturing areas of three or more image capturing units are overlapped or an overlapping direction is other than the above-described width direction. Further, according to the present exemplary embodiment, the weight w is calculated based on the center position of the overlapping area, however, a reference position for calculating the weight w is not limited to the above-described one, and a lowest frequency position (texture-less area) in the overlapping area may be regarded as the reference position. In this case, a failure of an image after projection can be appropriately suppressed even in the case of an input image including a lattice pattern. Further, according to the present exemplary embodiment, a plurality of coordinate values calculated based on the captured images of a plurality of the image capturing units are subjected to weighting addition to calculate the unified coordinate values, however, the calculation method is not limited to the above-described one, and an interpolation method and the like can be applied.

In step S67, the projection image generation unit 224d generates the projection images to be projected by the respective projection units 301 to 303 to display the input image on the screen 501. In step S67, the projection image generation unit 224d generates the projection images of the respective projection units 301 to 303 from the input image by using the first transformation amount and the second transformation amount and applying a following formula (4).

dst(pu,pv)=src(lpu,lpv) (4)

In other words, the projection image generation unit 224d performs geometric transformation using the first transformation amount in the area outside of the overlapping area to generate the projection image from the input image. On the other hand, the projection image generation unit 224d performs geometric transformation using the second transformation amount in the area corresponding to the overlapping area to generate the projection image from the input image. As described above, the projection image generation unit 224d can uniquely determine the projection image by using the second transformation amount. In this regard, interpolation processing is required in the actual processing because the coordinate values (pu, pv) of the projection image are integers, whereas the coordinate values (lpu, lpv) of the input image are real numbers.

By the above-described processing, the projection images of the respective projection units 301 to 303 are generated. The projection image generation unit 224d outputs the generated projection images to the display control unit 205, and the display control unit 205 outputs the input projection images to the respective projection units 301 to 303. Accordingly, the respective projection units 301 to 303 project the images to the screen 501.

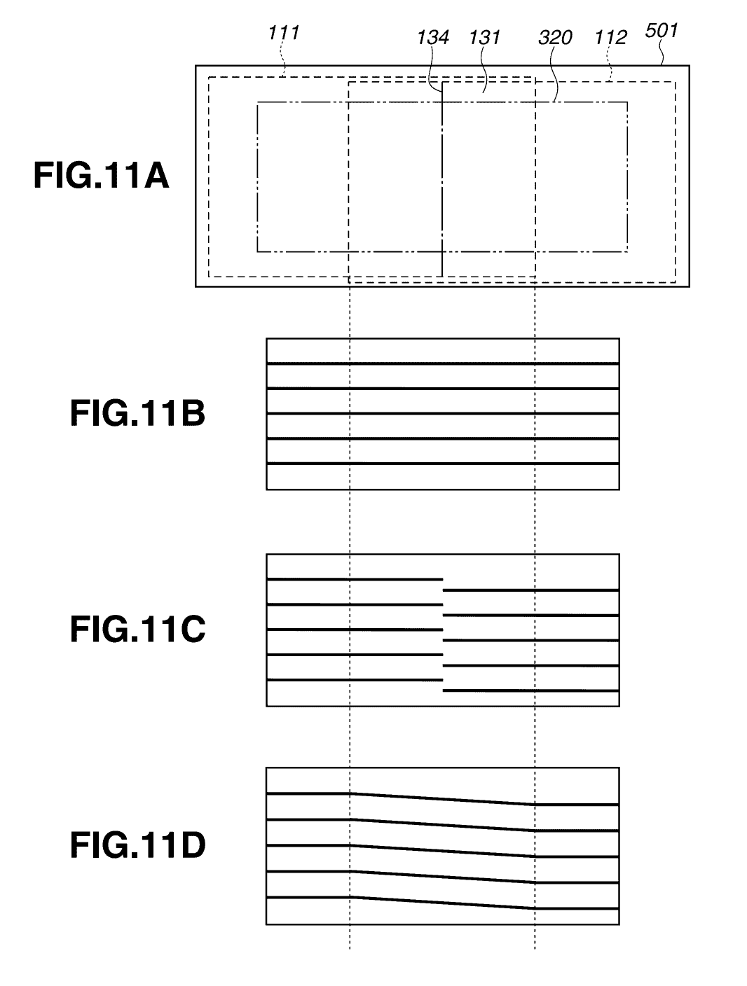

FIGS. 11A to 11D illustrate an effect of the present exemplary embodiment. In FIG. 11A, an area 320 surrounded by an alternate long and two short dashes line indicates the projection area on the screen 501. An alternate long and short dash line 134 indicates a center line of the overlapping area 131. FIG. 11B illustrates the input image.

FIG. 11C illustrates an image projected to the projection area 320 according to a comparative example. The comparative example generates an image projected to a left side of the projection area with respect to the center line 134 from the transformation amount calculated based on the correspondence information of the image capturing unit 101 and generates an image projected to a right side of the projection area from the transformation amount calculated based on the correspondence information of the image capturing unit 102. In this case, it can be understood that a failure occurs in the projected image at a position of the center line 134 of the overlapping area 131. This is because that the first correspondence information obtained by calibration of the image capturing unit 101 and the image capturing unit 102 with respect to the screen 501 includes an error, and the image capturing unit serving as the reference of the projection image generation is changed at the position of the center line 134 in a state including the error.

In contrast, according to the present exemplary embodiment, the projection image correction unit 224 generates the projection image from the transformation amounts respectively calculated based on the correspondence information pieces of both of the image capturing units 101 and 102 in the overlapping area 131 in which the image capturing areas of the image capturing units 101 and 102 are overlapped with each other. More specifically, the projection image correction unit 224 calculates the second transformation amount by interpolating (blending) a plurality of first transformation amounts respectively calculated based on the correspondence information pieces of both of the image capturing units 101 and 102 in the overlapping area 131. Further, the projection image is generated based on the second transformation amount in the overlapping area 131. FIG. 11D illustrates an image projected to the projection area 320 according to the present exemplary embodiment. As illustrated in the drawing, a failure of the projected image can be suppressed in the overlapping area 131.

As described above, according to the present exemplary embodiment, the image processing apparatus 200 can suppress a failure of the image after projection when the geometric correction of the projection image is performed using the captured images of a plurality of the image capturing units.

When the projection image of each projection unit is generated, the image processing apparatus 200 obtains the first correspondence information indicating the correspondence relationship between pixels of the input image and the captured image and also calculates the second correspondence information indicating the correspondence relationship between pixels of the projection image and the captured image. Further, the image processing apparatus 200 calculates the first transformation amount as the geometric transformation amount from the projection image to the input image based on the first correspondence information and the second correspondence information. The first transformation amounts calculated at that time are respectively calculated based on the captured images of a plurality of the image capturing units 101 and 102. Thus, when the first correspondence information includes an error due to errors of the image capturing unit/screen calibration and the image capturing unit calibration (camera calibration), the first transformation amount has a plurality of values in the area corresponding to the overlapping area of the image capturing area.

If there is a plurality of the first transformation amounts which are the geometric transformation amounts from the projection image to the input image, the projection image cannot be uniquely determined based on the input image when the projection image of the projection unit is generated. In addition, if the image capturing unit serving as the reference of the projection image generation is changed at a certain reference line, a failure occurs in the images after projection at the above-described reference line (the center line 134 in FIG. 11C) as illustrated in the above-described FIG. 11C.

In contrast, according to the present exemplary embodiment, the image processing apparatus 200 calculates the second transformation amount which is obtained by transforming a plurality of the first transformation amounts to a single transformation amount in the area corresponding to the overlapping area of the image capturing area. More specifically, the image processing apparatus 200 calculates the second transformation amount by performing weighting addition on the plurality of the first transformation amounts. In this regard, the image processing apparatus 200 performs the weighting addition on the plurality of the first transformation amounts based on the center position of the overlapping area. In other words, the second transformation amount changes according to a distance from the center position of the overlapping area, and the image processing apparatus 200 can calculate the second transformation amount so that the geometric transformation amount from the projection image to the input image smoothly changes in the image.

Thus, the image processing apparatus 200 can appropriately suppress a failure of the image after projection in the overlapping area of the image capturing area which is caused due to an error included in the image capturing unit/screen calibration and the image capturing unit calibration (camera calibration).

Next, a second exemplary embodiment of the present invention is described.

According to the above-described first exemplary embodiment, the case is described in which the second transformation amount is calculated with respect to the coordinate values of the projection image projected to the overlapping area of the image capturing area. According to the second exemplary embodiment, a case is described in which the second transformation amount is also calculated with respect to coordinate values of a projection image projected to an area corresponding to a peripheral area of the overlapping area.

When the overlapping area is small (a horizontal width is narrow), if the second transformation amount is calculated in the overlapping area and a projection image is generated as described in the first exemplary embodiment, it seems for a viewer that the image is abruptly changed. In other words, the viewer feels that a failure occurs in the image. Thus, according to the second exemplary embodiment, the second transformation amount is also calculated with respect to the coordinate values of the projection image projected to an area outside of the overlapping area to suppress a failure of the image after projection. Hereinbelow, the second exemplary embodiment is described focusing on portions different from the above-described first exemplary embodiment.

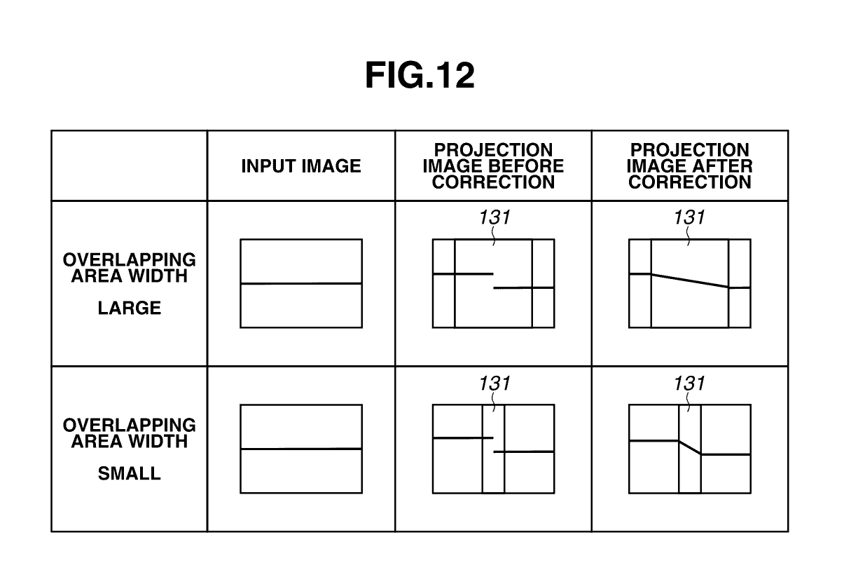

First, influence of a size (width) of the overlapping area on the image after projection is described with reference to FIG. 12.

FIG. 12 illustrates a difference in images after projection due to a difference of widths of the overlapping areas 131 when a single straight line as illustrated in an input image is projected. When the projection images are projected without correction (the projection images before correction), the line does not become a single straight line in each of the images after projection regardless of the width of the overlapping area 131, and failures occur in the images. The projection image before correction is a projection image obtained by generating an image to be projected to the projection area on the left side of the reference position of the overlapping area 131 based on the correspondence information of the image capturing unit 101 and generating an image to be projected to the projection area on the right side of the reference position based on the correspondence information of the image capturing unit 102.

Images of the projection image after correction in FIG. 12 are images after projection according to the above-described first exemplary embodiment. In this case, when the width of the overlapping area 131 is large, a line corresponding to the straight line in the input image is a single line even it is inclined, and a failure of the image after projection can be minimized. In contrast, when the width of the overlapping area 131 is small, the line corresponding to the straight line in the input image is a single line but the inclination thereof is large, and the image is abruptly changed in a small area. In other words, it is hard to say that a failure can be prevented in the image after projection. As described above, a failure of the image after projection is greatly affected by the width of the overlapping area 131. When the width of the overlapping area 131 is sufficiently large, a failure of the image after projection can be suppressed only by the correction of the projection image to be projected to the overlapping area 131. However, when the width of the overlapping area 131 is small, correction is required to the projection image to be projected to the outside area of the overlapping area 131.

According to the above-described first exemplary embodiment, the second transformation amount calculation unit 224c calculates the coordinate values (lpu, lpv) of the input image using the above-described formulae (3) with respect to the area corresponding to the overlapping area regardless of the width of the overlapping area. In contrast, according to the present exemplary embodiment, the second transformation amount calculation unit 224c changes the calculation method of the second transformation amount according to the width of the overlapping area.

More specifically, when the width of the overlapping area 131 is larger than or equal to a predetermined threshold value thresh, the second transformation amount calculation unit 224c calculates the coordinate values (lpu, lpv) of the input image after correction using the above-described formulae (3) as with the first exemplary embodiment. On the other hand, when the width of the overlapping area 131 is less than the above-described threshold value thresh, the second transformation amount calculation unit 224c calculates the coordinate values (lpu, lpv) of the input image after correction using following formulae (5). The threshold value thresh is determined according to a size of the screen, eyesight of a viewer, a viewing environment, a content of an image to be projected, and the like. The threshold value thresh may be determined by a user depending on the situation.

$$\begin{matrix}[ Equation 3 ] & \\ ( tru 1 , trv 1 ) = ( lpu\_ 1 - pu 1 , lpv\_ 1 - pv 1 ) ( tru 2 , trv 2 ) = ( lpu\_ 2 - pu 2 , lpv\_ 2 - pv 2 ) \\ lpu = pu + tru 1 + ( tru 2 - tru 1 ) \frac{( cu - ( centeru - \frac{thresh}{2} ) )}{thresh} \\ lpv = pv + trv 1 + ( trv 2 - trv 1 ) \frac{( cu - ( centeru - \frac{thresh}{2} ) )}{thresh} & ( 5 )\end{matrix}$$

In the above-described formulae (5), (tru1, trv1) are transformation amounts on a left end of the overlapping area, (tru2, trv2) are transformation amounts on a right end of the overlapping area. (lpu_1, lpv_1) are coordinate values of the input image at the left end of the overlapping area calculated based on the captured image of the image capturing unit 101, and (lpu_2, lpv_2) are coordinate values of the input image at the right end of the overlapping area calculated based on the captured image of the image capturing unit 102. Further, (pu1, pv1) are coordinate values of the projection image at the left end of the overlapping area, and (pu2, pv2) are coordinate values of the projection image at the right end of the overlapping area. (lpu, lpv) are coordinate values of the input image to be ultimately calculated, and (pu, pv) are coordinate values of the projection image. (cu, cv) are coordinate values of the captured image, and (centeru, centerv) are coordinate values of the center position of the overlapping area 131. Furthermore, in the above-described formulae (5), cu is a coordinate value in the image coordinate system of the image capturing unit which is used as the calculation reference of the coordinate values centeru of the center position 132 of the overlapping area 131, and according to the present exemplary embodiment, the coordinate value cu_1 in the image coordinate system of the image capturing unit 101 is used.

The second transformation amount calculation unit 224c expands an area in which the second transformation amount is calculated to the peripheral area of the overlapping area 131 by applying the above-described formulae (5) and thus can realize a smooth change of the second transformation amount in the expanded predetermined area. The calculation method of the second transformation amount is not limited to the above-described one, and a method may be applied which estimates a transformation amount of an area which cannot be captured using an extrapolation method and performs weighting addition using the estimated transformation amount as with the first exemplary embodiment.

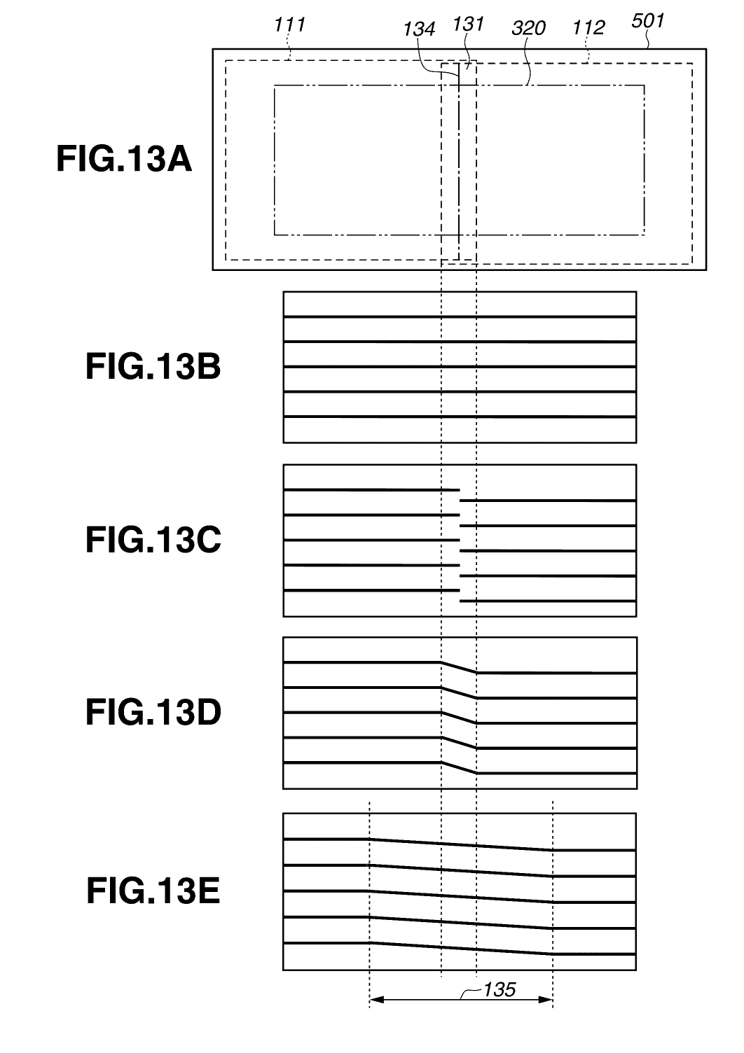

FIGS. 13A to 13E illustrate an effect of the present exemplary embodiment. FIGS. 13A to 13D are similar to FIGS. 11A to 11D excepting that the width of the overlapping area 131 is different.

As illustrated in FIG. 13D, when the projection image is generated to reduce a failure of the image after projection only in the overlapping area 131, the line has no cut and can be corrected to a single line. However, the position of the line is abruptly changed in a small area, so that it seems for the viewer that a failure occurs in the image.

In contrast, according to the present exemplary embodiment, the projection image is generated to reduce a failure of the image after projection with respect to the outside area of the overlapping area 131. FIG. 13E illustrates an image to be projected in the projection area 320 according to the present exemplary embodiment. The correction is performed on a correction area 135 including the outside area of the overlapping area 131, so that the change in the image can be smoothed than the image illustrated in FIG. 13D. As illustrated in the drawing, a failure of the image after projection can be minimized.

As described above, according to the present exemplary embodiment, when the width of the overlapping area is less than the threshold value thresh, the image processing apparatus 200 calculates the second transformation amount based on a plurality of the first transformation amounts in a predetermined area including the overlapping area and the peripheral area thereof. The above-described predetermined area is an area having a width corresponding to the threshold value thresh including the overlapping area. Accordingly, the image processing apparatus 200 can suppress a failure of the image after projection more appropriately.

### Other Embodiments

According to the aspect of the present invention, a failure of the image after projection can be suppressed when geometric correction of projection images is performed using captured images of a plurality of image capturing apparatuses.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-221993, filed Nov. 12, 2015, which is hereby incorporated by reference herein in its entirety.

What is claimed is:

1. An image processing apparatus for generating a projection image to be projected from a projection apparatus to a projected body, the image processing apparatus comprising:
a first derivation unit configured to derive a first transformation amount as a geometric transformation amount from the projection image to an input image to be displayed on the projected body respectively based on a plurality of captured images obtained by capturing a display image to be displayed on the projected body by a plurality of image capturing apparatuses of which image capturing areas are at least partially overlapped with each other;
a first obtainment unit configured to obtain information regarding an overlapping area in which the image capturing areas of the plurality of the image capturing apparatuses are overlapped with each other;
a second derivation unit configured to derive a second transformation amount as a geometric transformation amount from the projection image to the input image based on a plurality of the first transformation amounts derived by the first derivation unit and the information regarding the overlapping area obtained by the first obtainment unit; and
a generation unit configured to generate the projection image to display the input image on the projected body based on the first transformation amount derived by the first derivation unit and the second transformation amount derived by the second derivation unit.

2. The image processing apparatus according to claim 1, further comprising:
a second obtainment unit configured to respectively obtain first correspondence information pieces expressing correspondence relationships between pixels of the input image and a plurality of captured images obtained by capturing the input image displayed on the projected body by the plurality of the image capturing apparatuses; and
a third obtainment unit configured to respectively obtain second correspondence information pieces expressing correspondence relationships between pixels of the projection image and a plurality of captured images obtained by capturing a display image to be displayed on the projected body when the projection apparatus projects a projection image to the projected body by the plurality of the image capturing apparatuses,
wherein the first derivation unit derives the plurality of the first transformation amounts based on the first correspondence information and the second correspondence information.

3. The image processing apparatus according to claim 1, wherein the second derivation unit derives the second transformation amount so that the geometric transformation amount from the projection image to the input image smoothly changes in the image.

4. The image processing apparatus according to claim 1, wherein the second derivation unit derives the second transformation amount in an area corresponding to the overlapping area.

5. The image processing apparatus according to claim 1, wherein the second derivation unit derives the second transformation amount in an area corresponding to a predetermined area including the overlapping area and a peripheral area thereof.

6. The image processing apparatus according to claim 1, wherein the second derivation unit derives the second transformation amount by performing weighting addition on the plurality of the first transformation amounts.

7. The image processing apparatus according to claim 6, wherein the second derivation unit derives the second transformation amount by performing weighting addition on the plurality of the first transformation amounts based on a position corresponding to a center position of the overlapping area.

8. The image processing apparatus according to claim 6, wherein the second derivation unit derives the second transformation amount by performing weighting addition on the plurality of the first transformation amounts based on a position corresponding to a position at which frequency of the input image is the lowest in the overlapping area.

9. A method of image processing for generating a projection image projected from a projection apparatus to a projected body, the method comprising:
deriving a first transformation amount as a geometric transformation amount from the projection image to an input image to be displayed on the projected body respectively based on a plurality of captured images obtained by capturing a display image to be displayed on the projected body by a plurality of image capturing apparatuses of which image capturing areas are at least partially overlapped with each other;
obtaining information regarding an overlapping area in which the image capturing areas of the plurality of the image capturing apparatuses are overlapped with each other;
deriving a second transformation amount as a geometric transformation amount from the projection image to the input image based on a plurality of the first transformation amounts and the information regarding the overlapping area; and
generating the projection image to display the input image on the projected body based on the first transformation amount and the second transformation amount.

10. An image projection system comprising:
a projection apparatus;
a plurality of image capturing apparatuses; and
an image processing apparatus according to claim 1.

11. The image projection system according to claim 10, further comprising a plurality of the projection apparatuses, and
wherein the image processing apparatus generates the projection image to display partial images obtained by dividing the input image into a plurality of areas on the projected body with respect to each of the plurality of projection apparatuses.

12. A non-transitory computer-readable storage medium storing instructions that, when executed by a computer, cause the computer to perform a method comprising:
deriving a first transformation amount as a geometric transformation amount from the projection image to an input image to be displayed on the projected body respectively based on a plurality of captured images obtained by capturing a display image to be displayed on the projected body by a plurality of image capturing apparatuses of which image capturing areas are at least partially overlapped with each other;
obtaining information regarding an overlapping area in which the image capturing areas of the plurality of the image capturing apparatuses are overlapped with each other;
deriving a second transformation amount as a geometric transformation amount from the projection image to the input image based on a plurality of the first transformation amounts and the information regarding the overlapping area; and
generating the projection image to display the input image on the projected body based on the first transformation amount and the second transformation amount.
